(19) United States
(12) Patent Application Publication
(10) Pub. No.: US 2004/0163008 A1
(43) Pub. Date: Aug. 19, 2004

(54) Remote system management and operation services in a computer network

(76) Inventor: Roy Moon Kim, Sunnyvale, CA (US)

Correspondence Address: ROY KIM, #142, 370 ALTAIR WAY, SYNNYVALE, CA, 94087, US

(21) Appl. No.: 10/369,206

(22) Filed: Feb. 19, 2003

(51) Int. Cl. H02H 3/05

(52) U.S. Cl. 714/4

(57) ABSTRACT

A method and apparatus for management of a computer network is disclosed, that provides automated disaster recovery, rollout, and reconfigurable cluster and distributed computing operation for the computers and servers in a computer network. Further, a network adapter that allows for remote management for all types of systems is provided.

### RELATED APPLICATION

This application claims the priority benefit of U.S. Provisional Application No. 60/, filed on Feb. 20, 2002, entitled “REMOTE SYSTEM MANAGEMENT AND OPERATION SERVICES IN A COMPUTER NETWORK,” the entire disclosure of which is incorporated by reference in its entirety herein.

### FIELD OF THE INVENTION

The present invention relates to computer software and computer network management, and amongst other things to the remote system management and operation services in computer networks.

### BACKGROUND

Computer networks have grown not only in size, such as number of users or geographical coverage, but also in terms of the types of services and protocols a single network can provide and support. With the proliferation of services available on some computer networks is the increasing burden on system or network administrators of managing those services. A system administrator now typically has to install and manage software on several servers where each server typically hosts or provides one or more services to network users. Depending on the size of the network and the number of services, the day-to-day management, for example, installing, upgrading, and trouble-shooting, the software behind these services can become a tedious, error-prone, and time-consuming task for a system administrator. Another problem with diverse networks is that each end user, or server, may be have a slightly different configured operating system (OS). This is particularly true with regard to system administrators who are not familiar with the network, the servers, or the configuration of those servers.

A system administrator responsible for managing a computer network normally does so from a server and console, generically described as an administration server, in some cases this can for instance be a Web server. FIG. 1 is a block diagram of a computer network having multiple servers accessible by end-users and connected to an administration server not configured with the automated management capabilities. A computer network 102 has an administrator console shown as client 104 connected to an administrator server 106. Connected to administrator server 106 are multiple servers 108, which provide the functional services available to a user 114 of the network. From the perspective of administration server 106, servers 108 can be referred to as management clients, in that administrative server 106 manages the other servers 108 of the network. Although from the perspective of a user 114, they are servers that have particular functions or provide particular services. The end user 114 communicates with the network through a terminal server 112, which acts as the network gateway for the end user.

When an update, installation, or any type of maintenance is done on application software or to the operating system residing on one of the servers 110 or a new server is added to network 102, the system administrator must modify software on administration server 106 accordingly to identify that the changes or additions have been made. For example, if a new feature is installed on an existing mail server or a new mail server is being added, the administrator must note or remember the location and other information of the new feature or server at the time of the update. The administrator installs a new application on a server 110. This information, including the location of any management modules of the new application, which can be in the form of a Uniform Resource Locator, must then be entered at console 104. Once manually entered at administrator console 104, the information needed to manage the new software or server is reflected on administrator server 106. At this stage the location of any management modules on server 108 are available to the system administrator from administrator console 104. The new mail feature from the example cannot be managed or properly configured by end users until it is “registered” with the administrator server 106. Administration server 106 must know where to find the management modules associated with the new mail feature on management clients 108 before end-users can begin using the software. In many cases a corresponding change must be made to the application software or operating system of each end user 114 that utilizes the services of the network 102.

This is an inefficient process for the administrator and inconvenient for end-users who have come to expect new applications on their networks to be available for use as soon as possible. This process is also error-prone since the administrator has to perform manual or non-automated tasks such as writing down information on the new feature or server during installation, which must later be entered at an administrator console. This problem is exacerbated if there are dozens of servers, each with many applications (e.g. 30 is not unusual), which have frequent updates, corrections, or new versions that need to be installed in a timely and accurate manner. Further, since many computer networks have hundreds or thousands of users, the overhead for each change to a server exponentially increases the amount of work that needs to be performed. This makes managing network services not only inefficient, time-consuming, and error-prone, but also impractical.

Another problem in networks is the update and maintance of the end users 114 that utilize the network 102. The end users 114 also need to be updated, with new, modified applications and operating system components. Further, since end users have a great deal of control over the operating system and applications on their computer systems there are often situation where errors are created and generated, or simply are introduced from continued use. Administration then becomes a huge problem as it is impractical not only maintain each end user 114 to both just log the status and configuration of each end user 114.

Another major problem that system and network administrators are faced with is disaster recovery. For instance, in systems that utilize the Windows® operating system, a system fault can result in lost data and lead to the corruption of many of the files that include the set-up and preference parameters of the end users system. When these types of system faults occur, the administrative time and cost required to reset and reconfigure the end users systems, is generally very high. In the case of servers, disaster recovery the cost and time are not only expensive in terms the time to recover but also the time where the services, applications, or data that is maintained on the server is unavailable to the networks end users.

In addition the processing power of individual computers that make up the network are often not utilized during certain times, such as evenings and weekends. Further, many applications are compute intensive and require a great deal of processing power. This in turn increases the cost of the systems in the network that perform the compute intensive allocations, as well as their maintenance costs.

Therefore, it would be desirable to manage end-user application software and services available on a computer network from a central location by having any necessary software for managing those applications and services automatically registered at the central location during installation and accessible from a well-known location.

It would further be desirable to be able to perform disaster recovery for computer systems from a remote location.

In addition it would be desirable to increase the overall processing power available for applications of the network, while reducing the overall cost of the computers on the network.

### SUMMARY OF THE INVENTION

In one embodiment a method for managing a plurality of computers of a computer network. The method remotely determines the status of a computer, either a client or server, in the network, instructs a computer to load a new disk image and serves the new disk image to the computer.

In an additional embodiment a system for managing clients and servers in a network is provided. The system comprises a management program that determines when each of a plurality of management clients is to load a new disk image according to its status and that generates an instruction to load the new disk image. The system also comprises a data storage that the status of the management clients and an interface program that allows administrative access to the data storage and management program.

In a further embodiment a computer readable medium that stores computer programming instructions for managing a computer network is provided. The instructions comprise instructions for determining a status of a computer on the network to determine whether to provide a new disk image, providing an instruction to load the new disk image, determining if a response is received, and serving the new disk image if a response is received.

In yet a further embodiment a network interface adapter is provided. The network interface adapter comprises a medium access control unit, an interface for communicating with a computer, logic coupled to the medium access control unit that initiates a boot sequence of the computer in response to an instruction received over the network, and a memory comprising boot instructions that allow the computer to boot from the network interface adapter.

In yet another embodiment the present invention is directed toward a method for managing operation and resources of a computer network comprising determing the status of each of a group of computers that are part of the computer network, assigning each of the group of computers a disk image; instructing each of the group of computers to load a new disk image that corresponds the disk image assigned, waiting for a response to the instruction, and serving the assigned disk image to each of the computers.

In an additional embodiment the present invention is directed toward a computer network comprising a management server and a plurality of management clients. The management server instructs some of the management clients to load a new disk image from the computer network in accordance to the operating parameters of the management clients as determined by the management server.

### BRIEF DESCRIPTION OF THE DRAWINGS

FIG. 1 is a block diagram of a computer network having multiple servers accessible by end-users and connected to an administration server not configured with the automated management capabilities.

FIG. 2 is a block diagram of a computer network in accordance with one embodiment of the present invention.

FIG. 3 is a flow chart of management server operation in a computer network in accordance with one embodiment of the present invention.

FIG. 4 is a flow chart showing in greater detail steps 250 and 255 of management server operation, in a computer network in accordance with one embodiment of the present invention.

FIG. 5 is a flow chart showing in greater detail steps 250 in accordance with another embodiment of the present invention.

FIG. 6 is a flow chart of management server operation in a computer network according to a further embodiment of the present invention.

FIG. 7 is a flow chart of management client operation in accordance with an embodiment of the present invention.

FIG. 8 is a flow chart of management client operation in a computer network according to another embodiment of the present invention.

FIG. 9A is a flowchart showing in greater detail of kernel download depicted in FIG. 8 in accordance with one embodiment of the present invention.

FIG. 9B is a flowchart showing in greater detail of boot parameter download depicted in FIG. 8 in accordance with one embodiment of the present invention.

FIG. 10 is a flow chart of management client operation in a computer network according to a further embodiment of the present invention.

FIG. 11A is a flow chart of the operation in greater detail of step 550 in a computer network according to a further embodiment of the present invention.

FIG. 11B is a flow chart of the operation in greater detail of alternate step 550 in a computer network according to a further embodiment of the present invention.

FIG. 12 is a block diagram of a management server in accordance with an embodiment of the present invention.

FIG. 13 is a block diagram of a management client of a computer system according to another embodiment of the present invention.

FIG. 14 is a block diagram of a management client in accordance with one embodiment of the present invention.

FIG. 15 is a block diagram of a management client network interface adapter in accordance with one embodiment of the present invention.

FIG. 16 is a block diagram of a wireless network in accordance with one embodiment of the present invention.

FIG. 17 is a block diagram of a wireless network interface adapter in accordance with one embodiment of the present invention.

FIG. 18 is a flow chart of management server operation in a network with distributed or cluster computing configuration in accordance with one embodiment of the present invention.

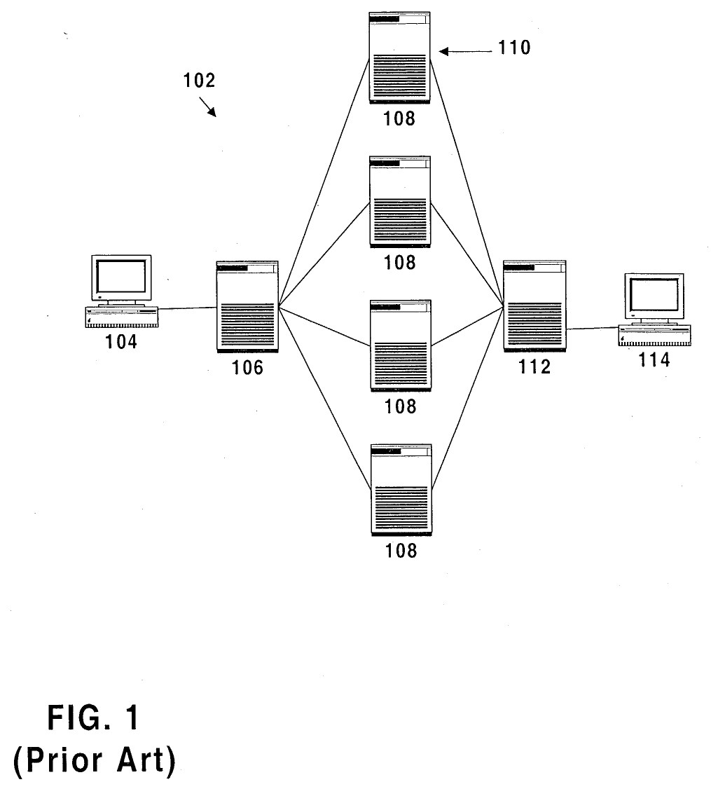

### DESCRIPTION OF THE PREFERRED EMBODIMENT

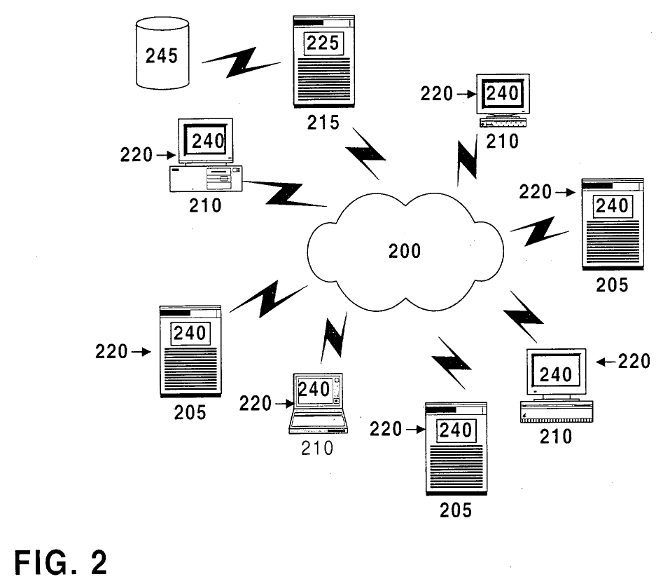

Referring to FIG. 2, a computer network 200 couples servers 205, clients 210 and management server 215. Each of the servers 205 and clients 210 includes a network interface adapter 212. Each server 205 provides one or more services to the clients 210, such as email, data storage, web services, etc.

Management server 215 manages one or more of the management clients 220 by keeping track of their status and then instructing the management clients 220 to perform selected back-up, disaster recovery, update, cluster computing, distributed computing, or rollout operations. In this way the management server 215 allows automated and centralized management of network 200, while at the same time increasing the processing power of the network. Management clients 220 that make up the network 200 can include all or some of the servers 205 and clients 210 on the network and are managed by management server 215.

Management server 215 comprises a management program 225 that determines when and whether one of the management clients 220 is to be instructed to perform selected backup, disaster recovery, update and rollout operations. The determination is based on a status of the management client 220, which is based upon both predetermined and dynamic parameters for each of the management clients 220. A network administrator can set some or all of the parameters that allow the management program 225 to make the determination as to whether and when to perform the selected operations. The determination can be based on a number of parameters including: (i) when an updated version of the operating system utilized by the management client is available for download; (ii) when an updated version of an application utilized by the management client is available for download; (iii) when a new application assigned to the management server is available for download; (iv) when a predetermined time limit has been reached; (v) an error or fault has been detected at the management client 220; (vi) a request has been made by the management client 220; or (vii) predetermined down times for the management client 220, so that cluster computing or distributed computing applications can be rolled out to increase the overall processing capacity of the network 200, for defined time periods when the management client is not being utilized for other applications by the network 200 or its user.

Each of the management clients 220 then performs the instructed operation by utilizing a modified operating system, server operating system or client operating system, and management client application 240. The disk image utilized may be a partial disk image, i.e. a portion of the file system, or a complete disk image.

In the presently preferred embodiment management clients 220 are managed through a management server 215 that preferably allows administrator access through a web interface. However, other preferred interfaces to management server 215 can be substituted, such as a command line interface, a designated workstation or a server that has other functions depending on the size of the network and the capacity of the server. In any case, management server 215 in the network can also provide other network services much like servers 210. Management server 215 has access to a database 245 that stores status information regarding each of the management clients 220 and other information that can be used for the determination as to whether and when selected management operations are to take place.

The administrator accesses management server 210 through a web client, which thereby allows the administrator to be almost any location. In the described embodiment, web client is equipped with a Web-based browser program that allows the administrator to access management server 215 and, more specifically to configure and update the system parameters of management program 225 and management client information in the database 245.

Management server 215 obtains information regarding the status of each of the management clients 220 that are part of the network 200 that are managed by management server 215. The specific parameters contained in the database 245 include, depending on how decisions as to loading new disk images are made include: (i) name of the management client; (ii) Medium Access Control (MAC) address of the management client 220; (iii) the OS version; (iv) applications and versions; (v) whether disaster recovery is enabled for the management client 220; (vi) whether rollout is enabled for the management client 220; and (vii) whether the management client 220 can request a new disk image, without first being instructed by the management server.

While a database 245 is the presently preferred method for storage of management and systems information, any other form of data storage can be used. Further the database or other data storage format need not be physically resident at or connected to management server 210, but only need be accessible by server 210. Database 245 is a reliable database that stores data, and can operate in hierarchical format, relational format or object-oriented format. Alternatively, database 245 need not be a database but simply a file such a flat file or the like. In addition, a log of all actions performed by management program 225 can be maintained as a log file or the like in database 245.

The management program 225 operates on management server 215 and can have a number of functions. It can instruct the management clients 220 to load a new disk image from any other server 245 or storage medium that is in communication with the network 200. Further, management program 225 is capable of instructing the management clients 220 to boot from another server 205 or client 210 that is part of the network 200, boot from its network interface adapter 212, reformat any local drive, mount any local drive, or upload current disk image of the management clients. Additionaly, the management program 225 can determine if the management client 220 is communicating with the network, whether they are operating, of management clients 220. In this way the management server 215 can determine if a fault or error has occurred and then perform the approprate disaster recovery functions. The management program 225 can also be configured to receive requests from the management clients 220 to perform any of the above-described functions, if its parameters are enabled and authorized for such operations. It is presently preferred that the management program 225 comprises one or more scripts to perform the above described functions.

The management server 215 can also be configured to rollout computing clusters or distributed computing applications, for limited time periods, for example at night time or other times when the majority of computers are idle or not in use. The management server 215 can instruct the management clients 220, which are part of the computing cluster, to save their current disk images and then to load a new disk image that is configured to operate in the cluster configuration and utilize the cluster communication protocols such as Parallel Virtual Machine (PVM) and Message Passing Interface (MPI). Also, Windows® clustering technologies can be utilized, so long as the disk image can contain all of the components for the individual computer to operate as part of the cluster.

By centralizing the functions described the system allows remote maintenance that reduces the total cost of network operation. Further by controlling the disk images on each system rollout and updating of operating systems and applications can be tightly controlled in order to reduce errors and faults. In addition, back up and recovery can be easily controlled.

The network 200 can be one of many different network types including a Local Area Network (LAN), wireless LAN, token ring network, wireless, coaxial cable, or Ethernet. Network 200 can also be a mixed media or type network, so long as the management server 215 can communicated with the management clients 220.

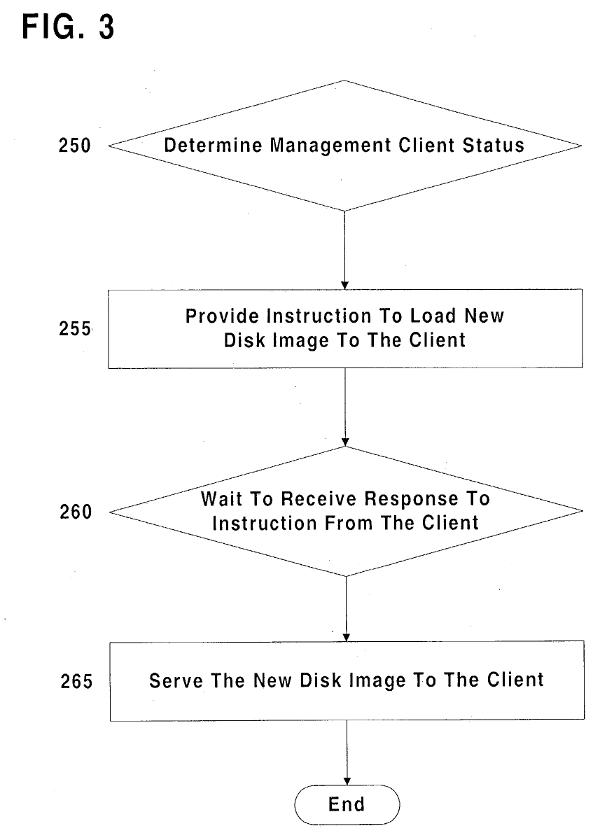

Referring to FIG. 3, a determination is made by the management program 225 that a new or updated application, operating system or disk image is to be loaded by one of the management clients based upon its status, step 250. In the case where more than one new disk images are available for load, the system may also determines which of the disk images the management client is to load as part of the determination as to whether a load is required. In some cases, even if there are more than one new disk images available, the status stored in the database 245 can be altered to identify which of the new disk images to load, so that no determination is necessary.

The term disk image as used herein means a file or files that comprise an operating system and components, applications, data files, or any combination of these. Also, a disk image can have some or all of the components of an operating system of application. The actual component files of a disk image are determined based upon the type of server 205 or client operating, the disk size, and preset preferences of the network administrators. For example, if the management clients 220 are network computers the disk image would probably not include data files. However, if the management clients 220 are personal computers or workstations with data storage, data files would likely be included as part of the disk image. If disk images had data files, then individual disk images would likely need to be assigned to the management clients 220 that are clients 210 on the network.

Once the determination is made, an instruction to load a new disk image is provided to management client 220 from management server 215, step 255. After providing the instruction to load a new disk image, the management server 215 waits until it receives a response that the instruction has been received by the management client, step 260. Once the management server 215 determines that a response to the instruction has been received, the management server serves the disk image for download by the management client 220, step 265. Alternatively, the management server 215 can provide a pointer to the management client 220 so that another server 205 on the network 200 serves the disk image to the management client 220. It is presently preferred that the disk images are stored on tape drives coupled to the management server 215.

The process described with respect to FIG. 3, lends itself to mass cloning of prototype disk images and operating systems. Further, it allows the administrator to control the configurations used by end user systems or servers, since once the administrator has one or more configurations that work as desired, e.g. having a high degree of stability, these configurations can be propagated to as many management clients 220 as required.

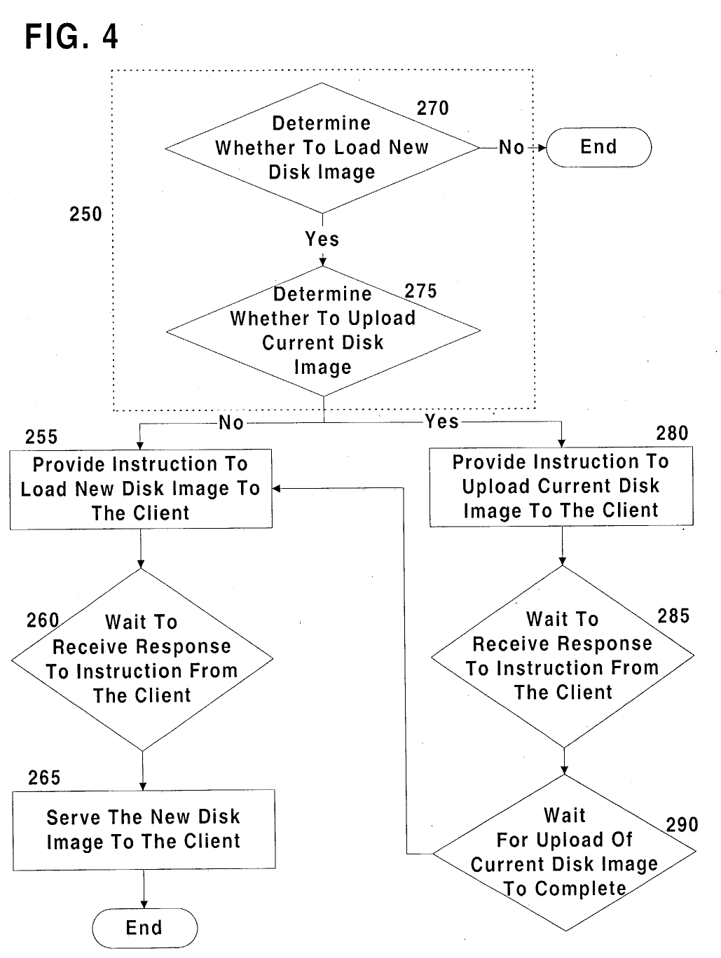

Referring to FIG. 4, the determination of whether a new or updated application, disk image is to be loaded by one of the management clients, step 250, is made up of two separate determinations. One determination is whether a new disk image is to be loaded by one of the management clients, step 270. If a load is to occur, a determination is made as to whether the current disk image residing on the management client 220 is to be uploaded to the network, step 275. If the management client 220 is not required to upload its current disk image then an instruction to load a new disk image is provided to management client 220 from management server 215, step 255.

If the management client is required to upload its current disk image then an instruction to upload the current disk image, operating system, or application(s) is provided to the management client 220, step 280. Upon sending the instruction to upload a new disk image, the management server 215 waits until it receives a response to the instruction, step 285. The management server 215 then waits until upload is complete, 290, and then an instruction to load a new disk image is provided to management client 220, step 255.

After providing the instruction to load a new disk image, the management server 215 waits until it receives a response that the instruction, step 260. Once the management server 215 determines that a response to the instruction has been received, the management server serves the disk image for load by the management client 220, step 270.

The ability to upload its current disk images allows for several advantages, including forensic diagnosis in the case of errors or faults, the ability to reload previous versions of drives, operating systems, or application(s) in the case of failed installation, the ability to track usage, and the ability to backup data of individual servers 205 or clients. Since, the disk images that are uploaded can be partial or complete the administrator can utilize it as part of a data back-up scheme, where changes made to a system are simply wiped away, while data, specially configured applications or other specialty settings are used in creating other disk images.

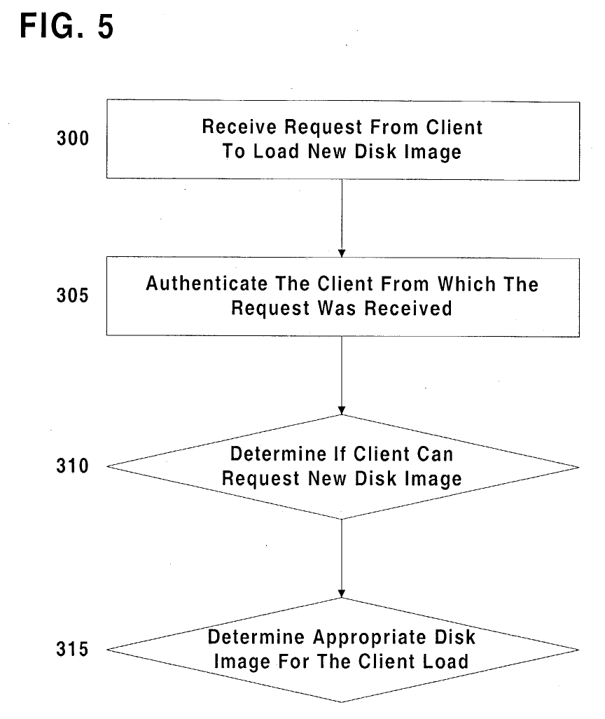

Referring to FIG. 5, if a request to load a new disk image is received from a management client 220, step 300, management server 215 then authenticates the management client 220 that sent the request, step 305. If the management client is authenticated, then the management server 215 determines the status of the management client 220 in order to determine whether the management client 220 can request a load, step 310, e.g. if the management client 220 is allowed to initiate disaster recovery or rollout.

If the management client 215 is allowed to initiate loading of a new disk image, then the management server 215 determines the appropriate disk image for the management client 220 to load, step 315. It is presently preferred that the request provided by the management client 220 is in the form of an Address Request Protocol (ARP) message, including the network MAC address of the management client 220 and that the authentication of the management client 220, step 310, is performed by determining if the network MAC address corresponds to a MAC address stored in the database 245.

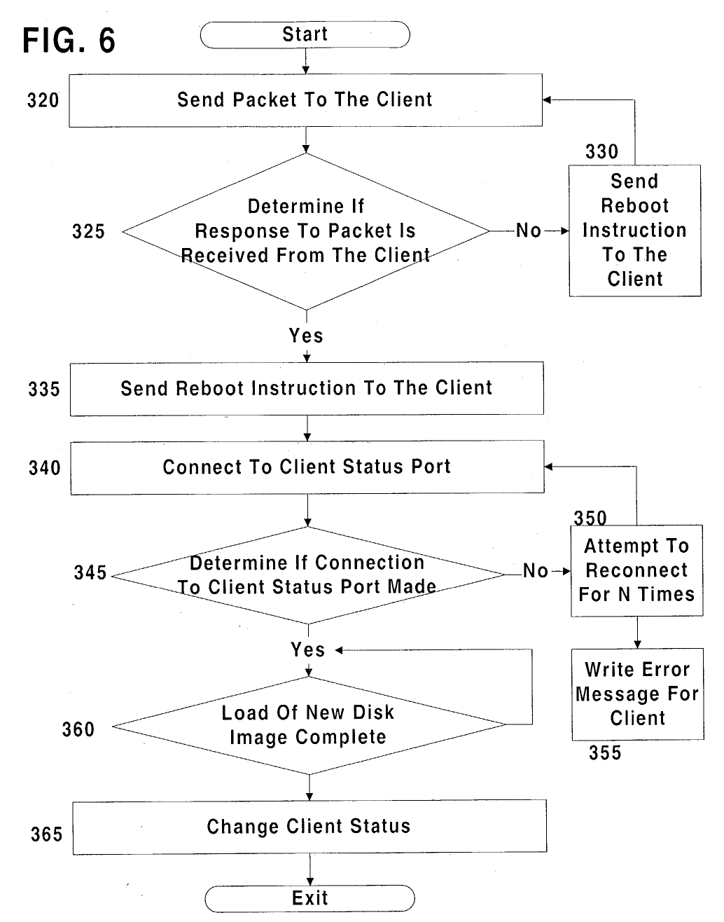

Referring to FIG. 6, the management server 215 sends a packet to the Internet Protocol (IP) address of the management client 220, step 320. The management server 215 then determines whether a response to the packet is received from the management client, step 325. If a response to the packet is not received, a reboot instruction is sent to the management client 220, step 330. The management server 215 will then send a packet to the IP address of the management client 220, step 320 and determine if a response to the packet is received, step 325. If a response is again not received, the management server can send another reboot instruction is sent to the management client 220, step 330. This loop is repeated a predetermined number of times, e.g. three times, and if no response is received after each of the repeated attempts an error message can be written into the status of management client 220 in the database 245 and the network administrator notified.

When a response to the packet is received from the management client 220, a reboot instruction is sent to the management client 215, step 335, in order to setup loading of the new disk image. The management server 215 then connects to the status port of the management client 220, step 340. The management server will determine whether the management server 215 has connected to the status port of the management client 220, step 345. If a connection is not made, the management server 215 will attempt to connect to the status port of the management client a predetermined number of times, step 350. If none of those attempts are successful, an error an error message can be written into the status of management client 220 in the database 245 and the network administrator notified, step 355.

Once a successful connection is made to the status port of the management client 220, the management server 215 waits until it receives a notification that the management client 220 has completed load and installation of the new disk image, step 360. Once the management server 215 receives a notification that the management client 220 has completed load and installation of the new disk image, it updates the status of the management client 215 in the database 245, step 365.

In the embodiment of FIG. 6, it is presently preferred that the reboot instruction is in a Wake-on-LAN format and that each of the management server 215 and management client 220 utilize a network interface adapter or system board capable of utilizing Wake-On-LAN functionality. The Wake-On-LAN feature of network interface adapter cards in personal computers allows network administrators to remotely boot powered off end systems. One popular technology for implementing the Wake-On-LAN feature is referred to as the “Magic Packet” technology, developed by Advanced Micro Devices (AMD), Inc. The “Magic Packet” technology developed by AMD involves transmission of a special packet that is identified by 16 duplications of the MAC address of the end station to be woken up without breaks or interruptions, inside a single packet. The network interface card is adapted to recognize this special packet, and signal the host system that it has received a Wake-On-LAN command. While the Wake-on-LAN technology is preferred, the boot instruction can provided through a serial port of the management client 215, through a modem card utilizing tip and ring, or other predetermined connections.

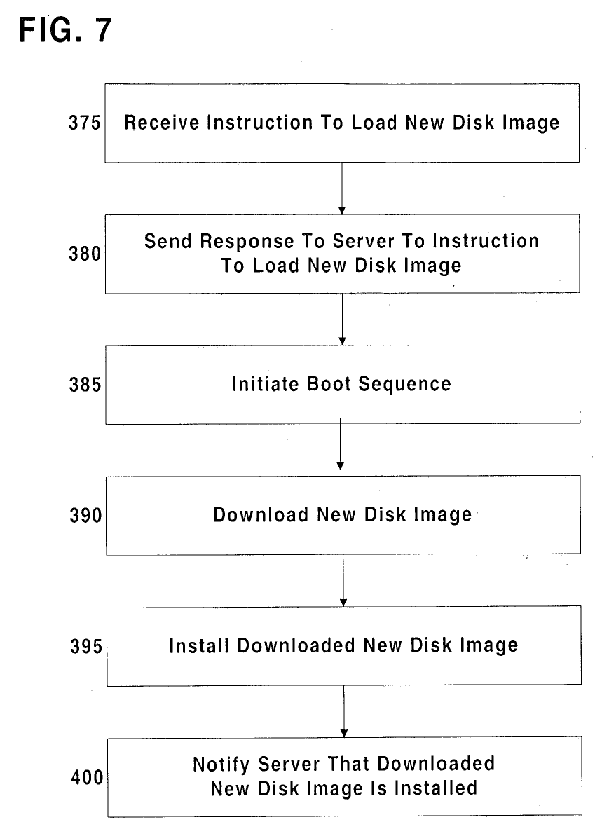

Referring to FIG. 7, the management client 220 receives the instruction to load a new disk image, step 375. In response to the instruction, the management client 220 responds that instruction has been received, step 380. The management client 220 then begins a boot sequence, step 385. The boot sequence is determined by the type of management client 220, in some cases the management client 220 may boot from one of the servers 205 of the network 200. Also, it is presently preferred that the network interface adapter 212 utilized by the management client, include a boot read-only memory (ROM) that allows the boot sequence to be initiated from the network interface adapter 212. This may be especially useful for management clients that utilize the Windows® operating the system, which has limited remote boot capability at this time. Further, an advantage of booting from the network interface adapter 212 is that it simplifies the operation of the network and will allow operation even if the operating system and boot sectors are corrupted on the management client 215 as may occur as a result of some viruses and catastrophic faults. The presently preferred boot sequence when the boot is from the network interface adapter 212, includes (i) obtaining an IP address for the management client 215 from the network 200; (ii) obtaining boot parameters for the management client 215 from the network 200; and (iii) loading a new disk image onto for the management client 215 from the network 200. In addition the boot sequence can include generating a disk image of the current disk or operating system.

After the boot sequence is completed, the new disk image is downloaded, step 390. It is presently preferred that the download of the new disk image is downloaded using Trivial File Transfer Protocol (TFTP), however any file transfer protocol including File Transfer Protocol (FTP), Hypertext Transfer Protocol (HTTP) or the like can be used. Once the download of the new disk image is complete, the new disk image is installed, step 395. After completion of the installation, the management client 220 notifies the management server that the installation of the new disk image is completed, step 400. Installation of the new disk image, can include formatting of one or more disks connected to the management client 220, creation of file systems, drive partitioning, compression of drives, mounting of drives, or any other system maintenance and operation processes.

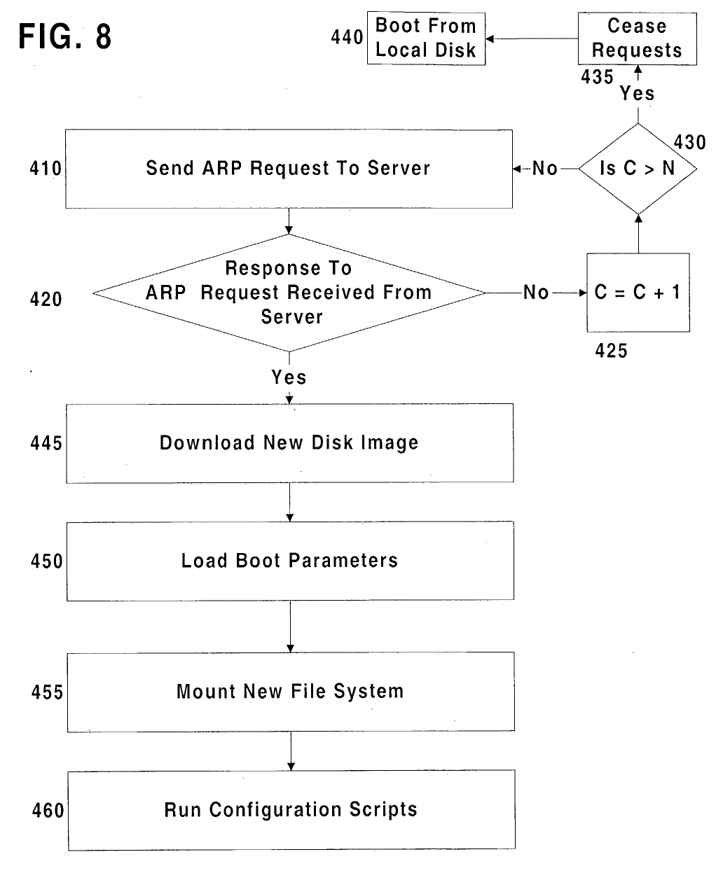

Referring to FIG. 8, a management client 220 sends a request to load a new disk image, step 410. The request is presently preferred to be an ARP request to include the MAC address of the management client 220 for the network and a request for a new disk image and IP address for the management client. The management client 220 then waits a predetermined amount of time, e.g. 1 second, for a response from the management server 215 to the request, step 420. If no response is received the management client 220 will increase its count of attempted requests for a new disk image, step 425. If the number of attempts reaches a preset limit, step 430, then management client 220 ceases sending additional requests, step 435, and boots from the local disk, step 440. If a response is received to the request, then management client 220 loads the new disk image from the server address specified in the response to the request, step 445. It is presently preferred that the response to the request includes an address of a server and disk image along with an IP address for the management client 220, so that download process is directed to a specific file. By specifying an address for the new disk image along with that of the server the process of serving the new disk image is made much simpler and allows the disk images to be stored oil any server 205 that is part of the network 200, since no processing is needed to determine which disk image to serve. It is also possible, as described with respect to FIG. 3, the management program 225 can operate so that management client 220 would need to respond to the management server 215 even after making its own request before receiving the address from which to load the new disk image.

The management client then loads the boot parameters, step 450. The boot parameters can be contained in a directory of the new disk image, as is presently preferred, or can be obtained from another server 205 or management server 215 of the network 200. After loading the boot parameters, the management client 220 will boot and mount the new file system of the new disk image, step 455. The mounting of the new file system can include creation of file systems, drive partitioning, compression of drives, mounting of drives, set up of the root directory, or any other system maintenance and operation processes that are requested as part of the boot parameters or required to successfully install the new disk image. Once the file system is mounted, the installation and configuration scripts included in the disk image are run so that the parameters for the hardware and applications are properly set, step 460. The process is then complete and the management client 220 is ready for use.

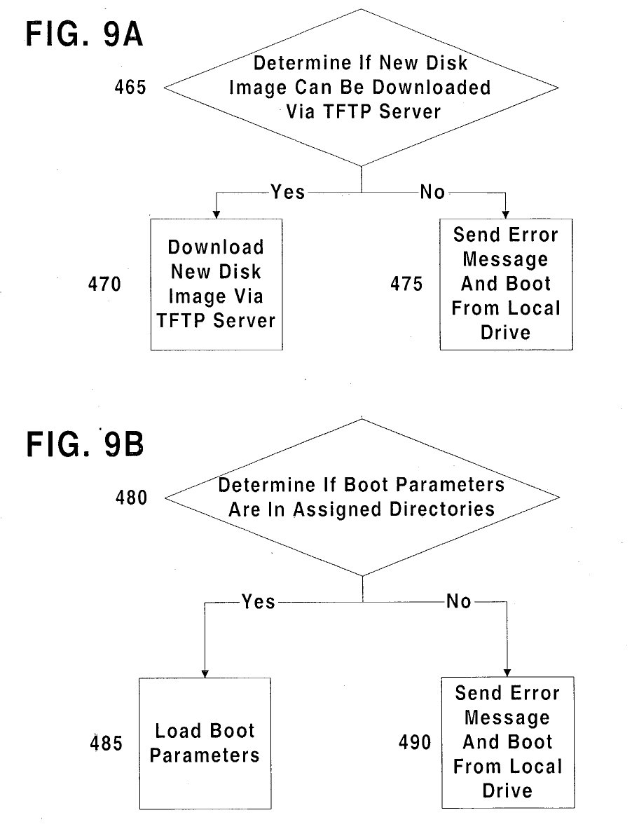

Referring to FIG. 9A, the management client 220 requests the new disk image from the address specified by the management server 215 and determines if it is available for download from designated TFTP server, step 465. If the new disk image is available for download, it is downloaded, step 470. If the new disk image is not available for download, then an error message is sent to the management server 215 and the management client 220 will boot from its local drive, if possible, step 475.

Referring to FIG. 9B, the management client 210 determines if the boot parameters are available for download or are included in the specified directories or files of the downloaded new disk image, step 480. If the boot parameters are available or found then the boot parameters are loaded, step 485. If the boot parameters are not available or found for download, an error message is sent to the management server 215 and the management client 220 will boot from its local drive, if possible, step 490.

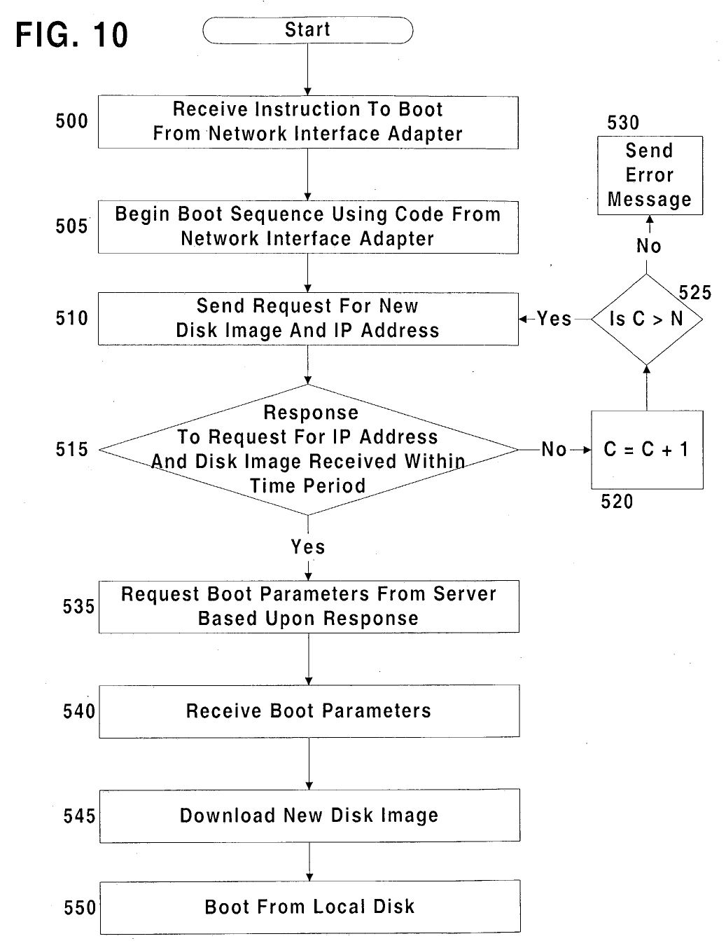

Referring to FIG. 10, the management client 220 is instructed to boot from network interface adapter 212, which contains a boot ROM or other memory containing a boot sequence, step 500. The instruction to boot from the network interface adapter can be initiated by the operating system of the management client 220 or by an instruction from the management server 215. If the boot sequence is initiated by the management server 220, it is preferred that the instruction to boot is in the Wake-on-LAN format and that management client 220 utilize a network interface adapter or system board capable of utilizing Wake-On-LAN functionality. Upon receiving the boot command, the management client 220 will boot from the network interface adapter 212, step 505. It is presently preferred that the boot sequence includes an instruction for the management client to request and IP address from the management server 215 and instructions for the management client 220 to obtain boot parameters from the network for the management client 215. The remote boot parameters include such things as the location of the new disk image to be downloaded and installed, the location of the configuration scripts for the new disk image, the location of any boot parameters for the new disk image, and another additional information required for installation of the new disk image.

The management client 220 then will request the new disk image and IP address from the management server 215, step 510. The management client 220 waits a predetermined time period for a response to the request, step 515. The time period can very depending on the detected network traffic, e.g. for low traffic systems time of up to five seconds would be appropriate and for high traffic systems times of approximately ten seconds would be appropriate. If a response is not received within the time period, the management client 220 will increase its count of attempted requests for a new disk image, step 520, and make another request, step 510. If the number of attempts reaches a preset limit, step 525, then management client 220 ceases sending additional requests, step 530, and an error message is sent to management server 215. If a response is received to the request, the management client 220 will request its boot parameters from the management server using the provided IP address as its return address, step 535. Upon receiving the boot parameters from the management server 215, step 540, the management client will then download the new disk image, configuration scripts, and any other necessary information, step 545. The management client 220 will then install and load the new disk image, step 550, and then will boot from its local disk, step 555.

By booting from the network interface adapter 212, the management client 215 can be controlled by the management server 215 in an operating system and set-up parameter independent fashion, thus allowing computers having different operating systems to be managed by a single management server 215. In addition, this allows for an improved method for disaster recovery since the management client 220 is capable of booting almost without regard to the type of error or fault that has occurred. This improves the disaster recovery capability of the management server, since an added feature of the boot sequence can be instructions that the management client 220 create a current disk image and upload the current disk image to the network so that the network administrators or other personnel have an opportunity to diagnose the error or fault.

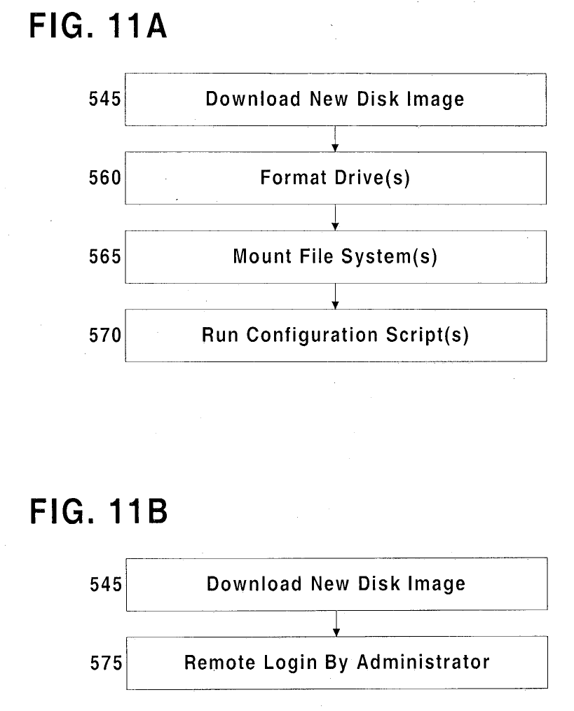

Referring to FIG. 11A, after the disk image and configuration scripts are downloaded, step 545, the management client 220 formats the appropriate drive(s), step 560. Once the drive(s) is formatted, the new file system is mounted, step 565. Once the new file system is mounted the configuration scripts are run and the management client is configured for operation, step 570.

Referring to FIG. 11B, after the disk image and configuration scripts are downloaded, step 545, the network administrator is capable of remotely logging into the management client 220, step 575. The remote login can be through TELNET, HTTP, RSH (for UNIX systems) or the like.

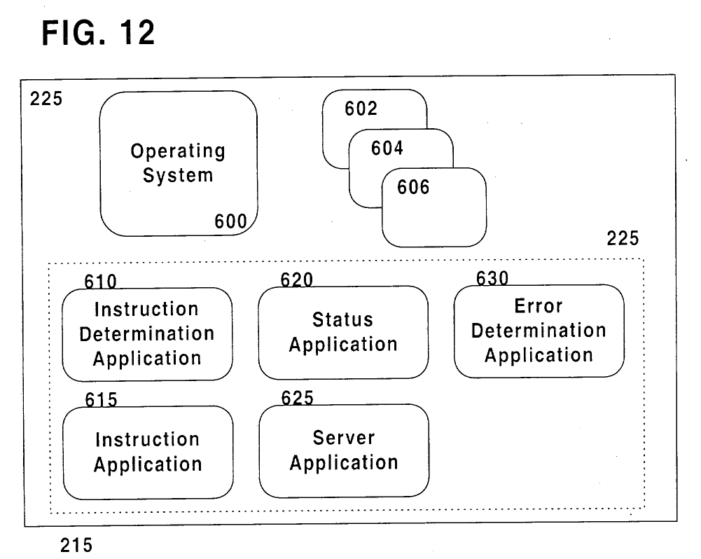

Referring to FIG. 12, management server 215 includes an operating system 600 and applications 602, 604 and 606, the exact number of applications varies and is dependent on the communication protocols used by the management server 215, the functions performed by management server 215, and the like. The management program 225 can logically be divided into component modules that perform the management functions for the network 200. Database module 320 communicates with the database 212 to read the status of the management clients 220, so that instruction determination application 510 can determine whether to instruct the management clients to install a new disk image. Database module can also be part of the operating system or can be a separate application from the management program 225. As described with respect to FIG. 3, the determination can be based on a number of criteria including: (i) that an updated version of the operating system utilized by the management client is available for download; (ii) an updated version of an application utilized by the management client is available for download; (iii) a new application assigned to the management server is available for download; (iv) a predetermined time limit has been reached; (v) an error or fault has been detected at the management client 220; or (vi) a request has been made by the management client 220. The database 245 will also contain information regarding each of the disk images available for download, including its operating system version, application(s) available and their version, and information regarding any data stored. The database 245 then also contains the MAC address of each management client, whether it can request a new disk image, as well as other information that is needed to make a determination as to whether and when to install a new disk image.

The instruction determination application 610 then provides commands to the instruction application 615, which issues the instructions to the management clients 220. The instructions can include: (i) beginning a boot sequence, whether locally, from a server 205 on the network, or the network interface adapter; (ii) load a new disk image, including download address information; (iii) create an image of the current disk image; (iv) remote boot parameter information, including download address information; (v) configuration script download information, including download address information; (vi) status checks, including IP packets or other status requests; (vii) determination of file names and locations on the current disk image; and (viii) any other necessary scripts for booting, uploading, downloading disk images or other required functions.

The status application 620 processes and waits for responses from the management clients, in response to the instructions generated by the instruction application 610. It then provides status information to the instruction determination application 610, so that the a follow up instruction can be issued, e.g. an instruction to serve a new disk image after a response to the instruction to download a new disk image is received. The server application 625 serves the disk images to the management clients 220 as instructed to by instruction determination application.

The error determination application 630, is used determine if an error or fault has occurred at any of the management clients 220. This can simply done by the instruction application 615 sending a packet to the IP or MAC address of the management client 220 and having the status application 620 determine whether a response is received, the error detection application can the determine that an error or fault exists if no response is received. Alternatively, the error determination application 630 can command the instruction application 615 send status queries to the management clients 220. It can then determine if any response indicate a fault or error.

While FIG. 12, depicts the management program 225 as divided into a number of different applications, the management program can also be a single program or divided into different applications then described with respect to FIG. 12, so long as the basic functions of instruction determination application, instruction application, and status application are provided. In addition for ease of use and debugging, it is presently preferred that the management program 225 consists of one or more scripts.

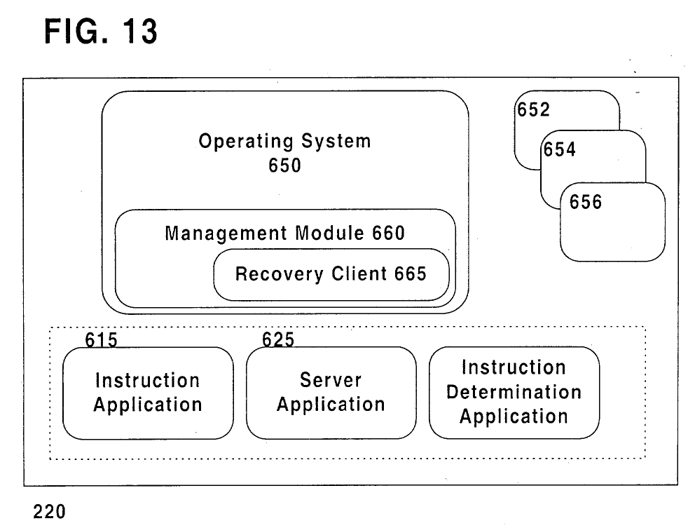

Referring to FIG. 13, a management client 220, which can be servers 205 or clients 210, includes an operating system 650, and applications 652, 654, 656. The operating system 650 and applications 652, 654, 656 are stored on one or more physical or logical drives 310. The actual number of applications depends on the type of server 205 or client 210 and its functions.

The operating system 650 comprises management module(s) 660. The management module(s) 660 comprises a recovery client 665, which allows the creation of a complete copy of all files and directories on a specified system with the exception of any files placed in the exclusion list and/or any file left open while the backup is running. The inclusion and exclusion features can be used to tailor the client's exact requirements for backups by excluding specific files or directories, or by only backing up individual files and directories. It is presently preferred, that the recovery client 665 is part of the operating system 660 kernel of the downloaded operating system or disk image.

The management client 220 also includes a recovery application 670 or rollout application 675. The recovery application 665 performs the functions of instructing the management client 220 to download the new disk image as instructed and create a file system, which is in an appropriate format for the operating system of the disk image being downloaded. The rollout application 675 performs the functions of instructing the management client 220 to download the new disk image as instructed and create a file system, which is formatted in an appropriate format for the operating system of the disk image being downloaded. Along with either recovery application 670 or rollout application 675, management client includes image application 680. The image application 680 performs the functions of instructing the management client 220 to create a disk image, of the predetermined files of the disk, and upload the disk image for further use, e.g. forensic investigation of faults or errors or backup, etc., when an instruction is received from the management server 215. Each of the recovery application 670 and rollout application 675 call the recovery client 312 to perform the appropriate file system configuration and mounting, and to process the downloaded disk image. It should be noted that it is possible to operate a system with only recovery application 670 or rollout application 675, without the other and without image application 680. Further, each of recovery application 670, rollout application 675 and image application 680 can be subdivided into separate applications that contain the proper calls to perform the functions that they perform. Also, in cases where a management client 220 contains both recovery application 670 and image application 680 or rollout application 675 and image application 680, they can be a single application. It is presently preferred that each of the recovery application 670, rollout application 675 and image application 680 comprise command scripts.

Further each management client 220 includes a network interface adapter 212, that has the includes a boot sequence that allows the management client 220 to boot from it, and that can cause the management client 220 to boot in response to an instruction received from network 200. However, the management clients 220 need not have network adapters of this type if remote boot commands are provided in other ways, e.g. through the management client serial port or if the operating system utilized by the management client 220 has the capability to initiate a boot sequence in response to a remote instruction.

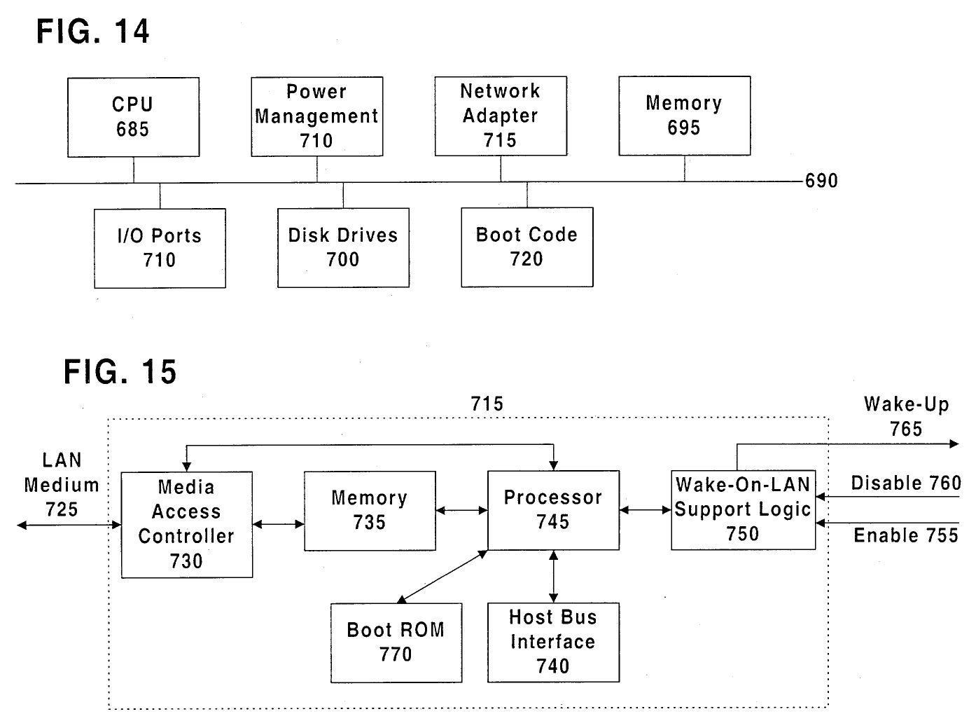

Referring to FIG. 14, network management functions which are executed using the Wake-On-LAN feature of the include waking up powered down management client 220 to allow for execution of network management functions, resetting management client 220 in the network, issuing commands to perform diagnostic functions, and providing specialized boot messages bypassing password protection, or bypassing other intermediate processes. In a preferred system, the Wake-On-LAN network interface adapter 212 implements an extended “Magic Packet” protocol, such as that referred to above in connection with the “Magic Packet Technology White Paper” issued by Advanced Micro Devices, Inc.

The management client 220 includes a central processing unit 685 and a system bus 690, which interconnects memory 695, drive(s) 700 or other large scale non-volatile memory, various input/output devices 705, such as keyboards, displays, scanners, or other peripherals. Management client 220 also includes power management circuitry 710. The power management circuitry 710 in this example is a coupled to the system bus 690, but may be interconnected with devices in the system in a variety of fashions.

Network interface adapter 715 implements the remote boot Wake-On-LAN features of the present invention. The network interface adapter 715 is coupled to the system bus 690, as well as to the power management circuitry 710. The network interface adapter 715 is coupled to a LAN network medium 725 for communication with management server 215 station and the rest of the network 200. The power management circuitry 710 represents a variety of available power management technology, which may implement power management features such as allowing for management client to go completely asleep, that is without power to the Central Processing Unit (CPU), or to go to various levels of reduced functionality and power consumption depending on the particular environment of the device. The network interface adapter 715 allows the system to receive Wake-On-LAN packets across the LAN medium 725, and in response to issue signals to the power management circuitry 710, which results in waking up the CPU, or otherwise bringing up the system to allow functions specified by the management server 215 to be performed, such as downloading and installing new disk images and uploading current disk images.

Boot code memory 720 is coupled to the power management circuitry 710 and the network interface 715 through system bus 690. It is also possible that the CPU 685 includes a reset function. The power management logic 710 and the network interface adapter 715 may issue a system reset command to the CPU 685 directly. Also, other diagnostic processes can be incorporated into the management client 220 related to power management which could be signaled using a Wake-On-LAN function.

The network adapter 715 then can when instructed by the management server, communicate to the CPU 685 through the system bus 690 to instruct the CPU 680 to boot from the boot code stored on the network interface adapter 715, as described with respect to FIGS. 10, 11A and 11B.

The diagram of FIG. 14 is a simplified diagram meant to represent any one of a variety of personal computer or workstation architectures, such as Intel X86 based computers, Apple Macintosh computers, Sun Microsystems Workstations, or any other computer system.

Referring to FIG. 15 network interface adapter 715 includes a medium access control MAC unit 730 that interfaces with local area network medium 725. The MAC unit 730 is coupled to memory 735. The memory 735 is coupled to a host bus interface 740, which interfaces to system bus 685. A processor 745 is coupled to the MAC unit 730, the memory 735, and the host bus interface 740, and manages the transfer of network packets from the LAN medium to the system bus, and vice versa. The processor 745 can consist of dedicated logic, a program controlled processor, or combinations of dedicated logic and a program controlled processor. Also implemented on the network interface adapter 715 is Wake-On-LAN logic 750. Wake-On-LAN logic 750 includes a disable input 755 by which the management client 220 is able to turn off the Wake-On-LAN function, and an enable input 760 by which the management client 220 is able to turn on the Wake-On-LAN function. The Wake-On-LAN logic 750 can be implemented in a processor 745 that is program controlled, via a software routine stored on the chip in read only memory, or non-volatile memory, which would allow for updates to the program.

Wake-On-LAN logic 750 also provides for generating a wake-up command on line 765. The wake-up command on line 765 is X bits wide in various embodiments, where X varies from 1 up to any number of bits required to support a variety of system and power management commands which might be carried in a Wake-On-LAN packet. The Wake-On-LAN logic 750 can be implemented using dedicated logic, or as part of a program executed by the processor 745, or as combinations of dedicated logic and software executed by the processor 745.

The memory 735 is implemented using a RAM, or first in/first out (FIFO) memory, or any other of a variety of approaches depending on the particular implementation of the device. As mentioned above, one embodiment of the present invention provides an extension of the “Magic Packet” technology currently in use.

In addition, processor 745 can relay boot instruction through the host interface from the boot ROM 770, when an instruction is received from the management client 220, that is initiated by the recovery application 665 or the rollout application 670. The boot ROM 770 is programmed prior to being inserted into the network adapter and is therefore configured to use boot ROM 770 upon initiation of the boot sequence. The basic input/output system (BIOS) may need to be configured to use Wake-on-LAN and the network adapter by specifying the order of booting for the management client 220. The configuration requirements will vary by the computer or network interface adapter 715 according to the manufacturers specification. The presently preferred boot sequence includes: (i) obtaining an IP address for the management client 215 from the network 200; (ii) obtaining boot parameters for the management client 215 from the network 200; (iii) downloading a new disk image onto for the management client 215 from the network 200. The new disk image maybe loaded from an attached floppy drive, a secondary drive, a memory card emulating a floppy drive, a CD-ROM image or any other boot methods available to the BIOS of the management client. It is presently preferred that the boot ROM 770 is an Electrically Programmable Read Only Memory (EPROM), however any non-volatile memory, including Electrically-Erasable Programmable Read Only Memories (EEPROMs), can be used to store the boot information on the network interface adapter 710.

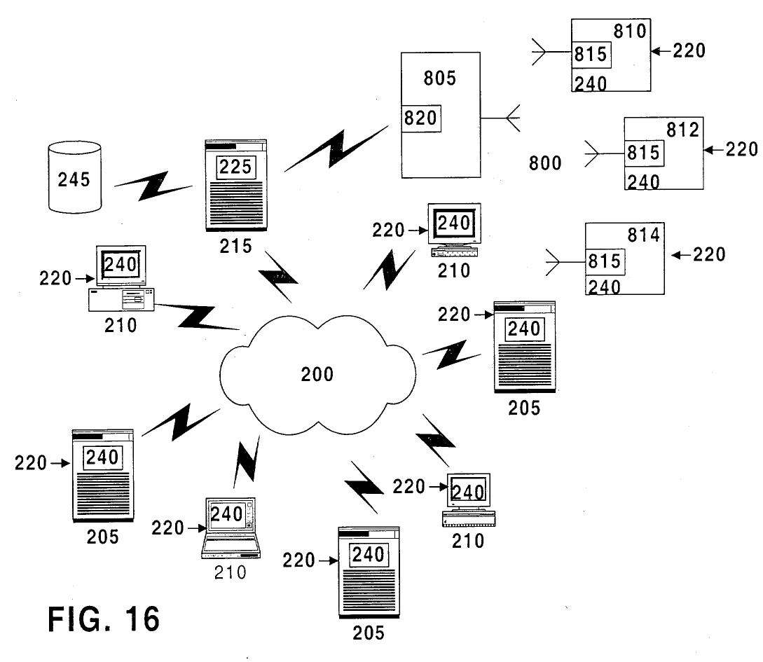

Referring to FIG. 16, a schematic overview of a wireless LAN 800 includes a gateway 805, sometimes referred to as the access point, which serves as the wireless communication terminal for all communication between a plurality of wireless network stations 810, 812 and 814 and the network 200. The gateway 805 is connected via suitable network interface adapter 815 to a wired network 200 for communication with other access points 2. It is to be understood that in LAN 1 the actual number of wireless network stations 3 may be 0 (zero) or more. The wireless network stations 810, 812 and 814 may be mobile or located at fixed positions, so long as they connect to the network 200 by means of wireless data communication. The wireless network stations 810, 812 and 814 are management clients 220 of the management server 215, and have the appropriate information in the management database 245 so that the management program 225 can make the appropriate decisions as to whether to instruct the management clients 220, in this case the wireless network stations 810, 812 and 814 to download and install new disk images. Further, management client program 240 resides on each of the wireless network stations 810, 812 and 814.

Wireless LANs are generally implemented according to the standard as defined by the International Standards Organization (ISO/IEC) 8802-11 international standard (Institute of Electrical And Electronic Engineers (IEEE) 802.11). IEEE 802.11 describes a standard for wireless systems that will operate in the 2.4-2.5 GHz ISM (industrial, scientific and medical) band and, in particular, focuses on the MAC (medium access control) and PHY (physical layer) protocols for access point based networks and adhoc networks. In access point based networks, (mobile) network stations within a group or cell can communicate only directly to an access point (e.g., a base station). This access point acts as base station for the communication cell and forwards messages to the destination network station within the same cell or through a wired distribution system to another access point, from which such messages arrive finally at the destination network station. In ad-hoc networks, the network stations operate on a peer-to-peer level and there is no access point or wired distribution system.

The 802.11 standard defines both the physical and medium access control protocols for communication over the air interface. The physical layer specification of the IEEE 802.11 encompasses three transmission options: one infrared option, direct sequence spread spectrum (DSSS) option, and frequency hopped spread spectrum (FHSS) option. Both spread spectrum techniques are used in the 2.4 GHz band because of wide availability in many countries. The IEEE 802.11 standard Supports the DSSS for use with Binary Phase Shift Keying (BPSK) modulation at a 1 Mbps data rate, or Quadrature Phase Shift Keying (QPSK) modulation at a 2 Mbps data rate. The FHSS is supported under 802.11 with Gaussian Filter Shift Keying (GFSK) modulation and two hopping patterns with data rates of 1 Mbps and 2 Mbps. Also higher bit rates are expected in the near future.

Security provisions are addressed in the standard as an optional feature. The data security is accomplished by all encryption technique known as the Wired Equivalent Privacy (WEP). WEP is based on protecting the transmitted data over the radio interface using an encryption key and an RC4 encryption algorithm. The IEEE 802.11 standard recommends 40 bit encryption keys but it also allows other key lengths. WEP, when enabled, only protects the data packet information and does not protect the physical layer header so that other mobile terminals in the network can listen to the control data needed to manage the network. However, the other mobile terminals cannot decrypt the data portions of the packet.

Referring again to FIG. 16, network management is performed as in a wired network. Since, each of the wireless network stations 810, 812 and 814 includes a wireless network interface adapter 815 that includes Wake-on-LAN functionality and a boot memory, which allows the wireless network stations 810, 812, an 814 to be instructed to initiate boot sequences by the management server 215 through the wireless network gateway 805 and to boot from the wireless network interface adapter 815. Although FIG. 16 depicts management sever 215, if there is no wired network 200 then management server 215 can be coupled directly to the wireless network 800, whereby the management server 215 would be a dedicated management server for the wireless network 800.

Operation of the management functionality would remain essentially the same for a wireless network would remain the same, except that communication between the management server 215 and the wireless network stations 810, 812, and 814 would be processed through the wireless gateway 805.

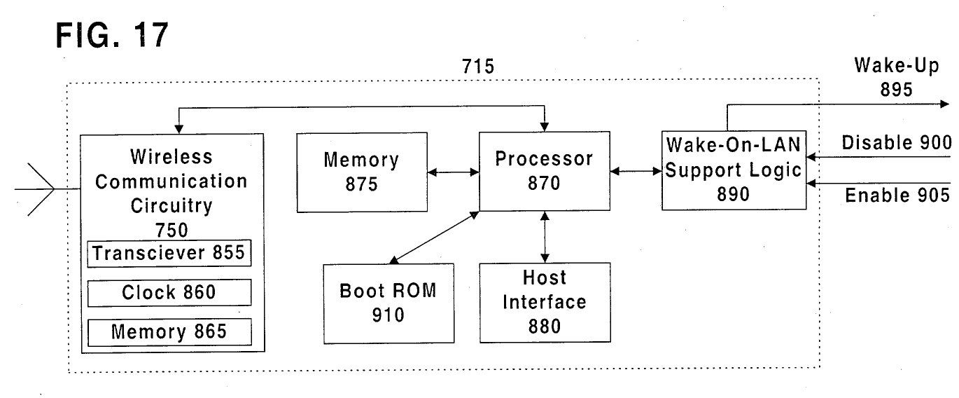

Referring to FIG. 17, wireless communication circuitry 850 contains the circuitry includes the logic for generating, receiving, decoding and encoding signals received over the wireless network 800 by the wireless network stations 810, 812 and 814. In many cases, the wireless communication circuitry 850 will include at the minimum a transceiver 855, clock 860 and buffer memory 865. The wireless communication circuitry 850 is coupled to processor 870 that controls operation of the wireless network interface adapter 815, which is preferably a network interface card such as a PCMICA card, a system board chip-set, or any other connection that Supports wireless networking. The processor 870 can consist of dedicated logic, a program controlled processor, or combinations of dedicated logic and a program controlled processor.

The processor 870 is also coupled to the memory 875, host interface 880, Wake-on-LAN logic 890 and boot memory 910. Wake-On-LAN logic 890 includes a disable input 900 by which the management client 220 is able to turn off the Wake-On-LAN function, and an enable input 905 by which the management client 220 is able to turn on the Wake-On-LAN function. The Wake-On-LAN logic 890 can be implemented in a processor that is program controlled, via a software routine stored on the chip in read only memory, or non-volatile memory, which would allow for updates to the program. The host interface 880 couples the wireless network interface adapter 880 to the wireless network station 810, 812 or 814 and is dependent on the type of connection, e.g. PCMCIA, host bus interface, or any other appropriate connection.

Wake-On-LAN logic 890 also provides for generating a wake-up command on line 895. The wake-up command on line 895 is X bits wide in various embodiments, where X varies from 1 up to any number of bits required to support a variety of system and power management commands which might be carried in a Wake-On-LAN packet. The Wake-On-LAN support logic 750 in various alternatives is implemented using dedicated logic oil the wireless network interface adapter, or as part of a program executed by the processor 870, or as combinations of dedicated logic and software executed by the processor 870.

In addition, processor 870 can relay boot instruction through the host interface from the boot ROM 910, when an instruction is received from the management client 220, that is initiated by the recovery application 665 or the rollout application 670. The presently preferred boot sequence includes: (i) obtaining an IP address for the management client 215 from the network 200; (ii) obtaining boot parameters for the management client 215 from the network 200; and (iii) downloading a new disk image onto for the management client 215 from the network 200. It is presently preferred that the boot ROM 770 is an EPROM, however any non-volatile memory, including EEPROMs, can be used to store the boot information on the wireless network interface adapter 815.

It is also possible to use the above described wireless network interface 815 also be setup to support other mobile telecommunication functionalities, such as the GSM functionality. Accordingly it is possible to extend the management equipment based on other kinds of wireless local area networking techniques, for instance in Bluetooth, High Performance Radio Local Area Network (HiperLAN) or Broadband Radio Access Network (BRAN) equipment.

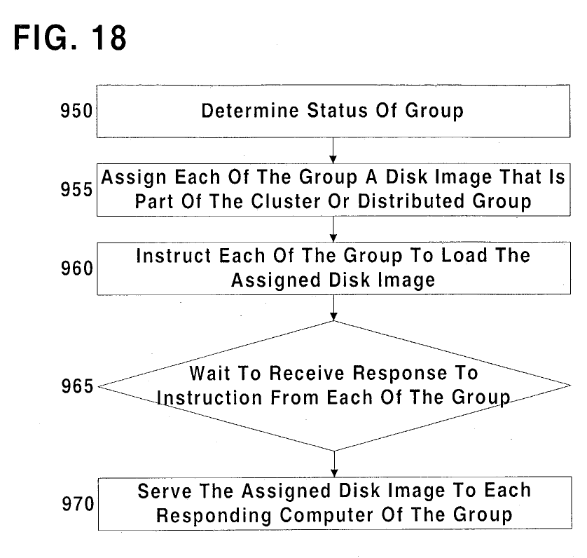

Referring to FIG. 18, the management server 215 determines the status of a group of management clients 220, both clients and servers that can be used for cluster computing or distributed computing operation, step 950. The determination of the group can be made by checking a preset group of management clients 220 to determine if they are available according to their database records, checking which of the management clients 220 are not currently being utilized, or some combination of the two. The management server then assigns each of the management clients 220 that is part of the group a new disk image, step 955. The assignment again can be based upon preset assignments by the network administrator, or can be dynamic based upon the processing speed, power and hard disk space of the management clients 220. The disk images that are assigned are stored in the network, e.g. in a tape drive that is attached to the management server 215 or at another server dedicated to partitioning and scheduling for the cluster, in the case of a cluster computing application. In the case of a distributed computing application, the data is partitioned and then divided amongst the disk images. Partitioning is based upon a predetermined partitioning algorithm.

After the disk images are assigned, the management clients 220 that are to be part of the cluster are instructed to download the assigned disk image, step 960. The instruction to each management client 220 is preferably an instruction reboot and download a new disk image from the network, e.g. a Wake-on-LAN packet. The management server then waits to receive a response to the instruction to load the assigned disk image, step 965. If the response to the instruction is received, then the assigned disk image is served to each management client 215 as appropriate, step 970.

The management server 215 can also instruct one or more of the management clients 220 to upload their current disk image, prior to loading the assigned disk image in order to reload the current disk image after a predetermined period or other event. For instance, if the management clients are only utilized to perform cluster computing or distributed computing applications at night, then in the morning the management server 215 can instruct each of the management clients 220 that is part of the group to download the previous disk image and allow the management client 220 to operate in stand-alone mode for users.

The management server 215 can in order to have the network function as a part-time clustered or distributed computing network instruct each of the management clients 220, which downloads a new disk image including the clustered or distributed computing functionality, to upload their current disk image prior to downloading the new disk image. In this way, the management server 215 can instruct the management clients 220 to download the current disk image that was uploaded after a predetermined time has elapsed or a specific event was triggered. The network is configured to perform the clustered or distributed computing application during times when users are not operating their computers or when servers 205 or clients 210 are not being used for any purpose of the network. This extends the processing power available to the network owner and allows a great increase of processing power without additional equipment cost.

In some cases, it may be advantageous for a single machine, e.g. a server 205 or client 210, to function as the master for the clustered or distributed computing application to allow a dedicated machine to control the partitioning, communication, and maintenance functions for the clustered computing application.

By utilizing multiple management clients 220 to perform the same function, e.g. database queries, the network 200 can fully utilize the full processing capability of database server or other server that otherwise would not be underutilized by a single machine or server performing a series of database or other related tasks.

The method and apparatus described with respect to FIGS. 3-17 can be utilized the different aspects, functions and features as described in FIG. 18.

Although the foregoing invention has been described in some detail for purposes of clarity of understanding, it will be apparent that certain changes and modifications may be practiced within the scope of the appended claims. Furthermore, it should be noted that there are alternative ways of implementing both the process and apparatus of the present invention. For example, although the invention has been described using a Web server as the administration server, a non-Web based server can also be used to run the management console program. In another example, database 212 can be a distributed database stored on the console host and various service hosts rather than at a single persistent database. Accordingly, the present embodiments ale to be considered as illustrative and not restrictive, and the invention is not to be limited to the details given herein, but may be modified within the scope and equivalents of the appended claims.

What is claimed is:

1. A method for managing a computer network comprising at least a first computer and a second computer, the method comprising:
determining a status of a first computer at the second computer to determine whether to provide a new disk image to the first computer;
providing, to the first computer, an instruction to load the new disk image from the network onto the first computer;
determining at the second computer, if a response to the instruction to load the new disk image is received at the first computer; and
serving the new disk image to the first computer, if the response to the instruction to load the new disk image is received at the second computer.

2. The method for managing a computer network according to claim 1, further comprising:
prior to providing the instruction to load the new disk image, providing an instruction to the first computer to create and upload a current disk image of the first computer,
determining at the second computer, if the first computer has completed uploading the current disk image; and
if the first computer has completed uploading the current disk image, then providing the instruction to load the new disk image.

3. The method for managing a computer network according to claim 2, further comprising
determining that an error has occurred on the first computer; and
wherein providing the instruction to the first computer to create and upload the current disk image is responsive to determining the error has occurred on the first computer.

4. The method for managing a computer network according to claim 1, further comprising
receiving a request from the first computer to load a new disk image,
determining if the first computer has a valid network identifier; and
wherein determining whether to provide a new disk image to the first computer comprises determining whether the status of the first computer corresponds to enabling the first computer to request a new disk image.

5. The method for managing a computer network according to claim 4, further comprising
determining, at the first computer, that an error has occurred on the first computer; and
wherein the request from the first computer to load the new disk image is sent from the first computer in response to the determining, at the first computer, that an error has occurred on the first computer.

6. The method for managing a computer network according to claim 5, further comprising:
prior to providing the instruction to load the new disk image, providing an instruction to the first computer to create and upload a current disk image,
determining, at the first computer, when the first computer has completed uploading the current disk image; and
wherein the request from the first computer to load the new disk image is received after first computer has completed uploading the current disk image.

7. The method for managing a computer network according to claim 1, wherein the instruction to load the new disk image comprises an instruction for the first computer to begin a boot sequence and wherein the instruction for the first computer to begin the boot sequence comprises a packet comprising a repeated the MAC address of the first computer in the computer network.

8. The method for managing a computer network according to claim 1, wherein the network comprises one or more of following network types a wireless LAN, token ring network, Local Area Network, and Ethernet.

9. The method for managing a computer network according to claim 1, further comprising
after determining a status of the first computer at the second computer, determining whether the first computer is responsive to communication from the second computer system;
if the first computer is not responsive, providing an instruction to the first computer to initiate a boot sequence and then determining whether the first computer is responsive to communication at a predetermined time;
ceasing to provide the instruction to the first computer to initiate the boot sequence, if the first computer is not responsive to communication from the second computer after the instruction to initiate the boot sequence has been provided a predetermined number of times;
if the first computer system is responsive, providing another instruction to the first computer to initiate the boot sequence; and
after providing the another instruction to the first computer to initiate a boot sequence, providing the instruction to load the new disk image.

10. The method for managing a computer network according to claim 9, further comprising connecting to a status port of the first the computer and providing, to the status port of the first computer, the instruction to load the new disk image after determining that the first computer is responsive and the instruction to initiate the boot sequence has been provided.

11. The method for managing a computer network according to claim 1, wherein the new disk image comprises a disk image configured to operate utilizing a cluster communication protocol.

12. A system for managing a computer network comprising at least one server comprising at least one fixed drive that provide services, and a plurality of clients comprising at least one fixed drive that utilize the services provided by the at least one server, comprising:
a management program that determines when each of a plurality of management clients comprising at least some systems of the at least one server and of the plurality of clients is to load a new disk image according to a status of each of the management clients and that generates an instruction to load the new disk image to the at least one management client;
a data storage capable of storing the status of each of the plurality of management clients, so that the management program can read and write the status of each of the plurality of management clients to the data storage; and
an interface program that allows administrative access to the data storage and management program.

13. The system for managing a computer network according to claim 12, wherein the management program further comprises an instruction determination application that is capable of determining whether to instruct each of the plurality of management clients to load the new disk image based upon a status of each of the plurality of management clients.

14. The system for managing a computer network of claim 13, wherein the management program comprises an instruction application capable of generating the instruction to load the new disk image for each of the plurality of management clients, a server application capable of serving disk images including the new disk image to each of the plurality of management clients, and a status application capable of determining if a response received from each of the plurality of management clients and that is capable of determining if a management client of the plurality of management clients has completed loading of a new disk image.

15. The system for managing a computer network according to claim 14, wherein the status application
determines whether each of the plurality of management clients is responsive to communication with the network;
if the management client is not responsive, the status application instructs the instruction application to provide an instruction to the management client to initiate a boot sequence and then the status application determines whether the management client is responsive to communication;
instructs the instruction application to cease providing the instruction to the management client to initiate the boot sequence, if the status application determines that the management client is not responsive to communication with the network after the instruction to initiate the boot sequence has been provided a predetermined number of times;
if the management client is responsive, the status application provides an instruction to the instruction application to provide an instruction to the first computer to initiate a boot sequence.

16. The system for managing a computer network according to claim 12, wherein the plurality of disk images comprises one or more of a first disk image comprising an operating system kernel including a recovery client, at least one application and a recovery client application; a second disk image comprising an operating system kernel including a recovery client, a rollout client application and at least one application; a third disk image comprising an operating system kernel including a recovery client, at least one application, a recovery client application, and an image upload client application; and fourth disk image comprising an operating system kernel including a recovery client, a rollout client application, at least one application, and a image upload client application.

17. The system for managing a computer network according to claim 12, wherein the computer network comprises one or more of following network types a wireless LAN, token ring network, Local Area Network, and Ethernet.

18. A method for managing operation and resources of a computer network that comprises a plurality of computers, the method comprising
determining a status of each of a group of computers of the plurality of computers that are part of the computer network;
assigning each of the group of computers a disk image that is a part of a group of disk images;
instructing each of the group of computers to load a new disk image that corresponds the disk image assigned that is part of the group of disk images;
waiting for a response to the instruction from each of the group of computers to load the new disk image that it was assigned; and
serving the new disk image that it was assigned to each of the computers that responded to the instruction load the new disk image.

19. The method for managing operation and resources of a computer network according to claim 18 further comprising
instructing each of the group of computers to upload a previous disk image residing on the computer to the network prior to loading the new disk image;
receiving a response to the instruction, from each of the group of computers, to upload the previous disk image to the network; and
serving the new disk image to each of the computers that responded to the instruction to load the previous disk image.

20. The method for managing operation and resources of a computer network according to claim 18 further comprising
determining whether the each of the group of computers is responsive to communication over the computer network;
if the a computer of the group of computers is not responsive, providing an instruction to the computer to initiate a boot sequence and then determining whether the computer is responsive to communication;
ceasing to provide the instruction to the computer to initiate the boot sequence, if the computer is not responsive to communication after the instruction to initiate the boot sequence has been provided a predetermined number of times;
if the computer system is responsive, providing an instruction to the computer to initiate a boot sequence; and
after providing the instruction to the computer to initiate a boot sequence, then providing the instruction to load the new disk image assigned to the computer.
